(19) United States
(12) Patent Application Publication
(10) Pub. No.: US 2026/0233194 A1
(43) Pub. Date: Aug. 13, 2026

(54) CRYSTALLINE ALUMINOBORATES, THEIR METHOD OF PREPARATION AND USE

(71) Applicant: UOP LLC, Rosemont, IL (US)

(72) Inventors: Kelsey Hodge, Hoffman Estates, IL (US); Benjamin Yuhas, Evanston, IL (US); Susan C. Koster, Carpentersville, IL (US)

(21) Appl. No.: 19/420,359

(22) Filed: Dec. 15, 2025

Related U.S. Application Data
(60) Provisional application No. 63/736,490, filed on Dec. 19, 2024.

(51) Int. Cl. B01J 20/02; B01J 20/30; C01B 21/092; C02F 1/28; C02F 101/34; C02F 101/36

(52) U.S. Cl. CPC B01J 20/0262; B01J 20/3071; B01J 20/3078; C01B 21/092; C02F 1/281; C01P 2002/72; C01P 2002/78; C02F 2101/34; C02F 2101/36

(57) ABSTRACT

An aluminoborate composition comprising an empirical formula:

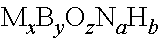

where M is a trivalent framework element, B is boron, O is oxygen, N is nitrogen and H is hydrogen, x is 3-8, y is 1-5, z is 16-25, a is 1 and b is 10-15. This composition is effective in removing per- and polyfluoroalkyl substances from water.

### FIELD OF THE INVENTION

This invention relates to a family of aluminoborates, their preparation and their use.

### BACKGROUND OF THE INVENTION

Per- and polyfluorinated chemicals (PFCs)c, or more specifically per- and polyfluoroalkyl substances (PFASs), are a large group of chemicals that have been used since the 1950s as ingredients or intermediates of surfactants and surface protectors for assorted industrial and consumer applications. During the last decade, several PFASs have been recognized as highly persistent, potentially bioaccumulative and toxic. In addition, many PFASs have been detected globally in the environment, biota, humans and food items. Initially, most attention was given to perfluorooctane sulfonic acid (PFOS) and perfluorooctanoic acid (PFOA), two PFAS chemicals found commonly in the environment, biota and human and most studied with regard to toxicity and ecotoxicity. PFASs are chemicals that contain one or more perfluoroalkyl moieties, —CₙF₂ₙ₊₁. In the past, PFASs were often referred to as “PFCs” (per- and polyfluorinated chemicals), but this term can also be understood as perfluorocarbons; perfluorocarbons contain only carbon and fluorine and have properties and functionalities different from those of PFASs. The materials of concern herein are the PFASs which are in turn divided into two sub-groups: non-polymeric and polymeric PFASs. Polymeric PFASs are used as coatings, insulators, films, and other materials. Perfluoroalkyl and polyfluoroalkyl substances (PFAS) are a group of compounds that include perfluorooctanoic acid (PFOA), perfluorooctanesulfonic acid (PFOS), and compounds produced by the GENX process such as 2,3,3,3-tetrafluoro-2-(heptafluoropropoxy)propanoate and heptafluoropropyl 1,2,2,2-tetrafluoroethyl ether. Such highly fluorinated compounds enjoyed widespread industrial use for many years, owing to their chemical durability, excellent surfactant properties, and key role as precursors to fluoropolymers including polytetrafluoroethylene.

Unfortunately, these same properties render PFAS resistant to degradation in the environment, while simultaneously leading to bioaccumulation when ingested over time. Some recent studies have linked PFAS to various detrimental health effects, most notably elevated levels of cholesterol, but also kidney cancer, testicular cancer, thyroid disease, and pregnancy-induced hypertension.

To date, several technologies have been employed to remove PFAS compounds from the environment and from drinking water. Such technologies include granular activated carbon (GAC), ion exchange resins, and reverse osmosis. GAC has emerged as a leading solution, but there is continued need for performance improvements so that the GAC is even more effective at removing PFAS compounds from the environment and from drinking water.

### SUMMARY OF THE INVENTION

The present invention relates to a new family of aluminoborate materials made with nitrate designated as NA-1. Accordingly, one embodiment of the invention is a layered, crystalline material. These aluminoborates are represented by the empirical formula:

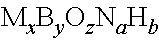

where M is a trivalent framework element such as aluminum or gallium, B is boron, O is oxygen, N is nitrogen and H is hydrogen and x is 3-8, y is 1-5, z is 16-25, a is 1 and b is 10-15. The NA-1 material is characterized in that it has the x-ray diffraction pattern having at least the d-spacings and intensities set forth in Table 1:

TABLE 1

| Position 2θ (°) | d-spacing (Å) | Intensity | Comment |
|---|---|---|---|
| 6.67-6.85 | 13.23-12.89 | w | b-s, sh |
| 7.25-7.47 | 12.18-11.82 | m | b |
| 8.60-8.92 | 10.27-9.91 | vs | b |
| 14.23-14.46 | 6.22-6.12 | w | b |
| 16.62-16.81 | 5.33-5.27 | vw | S |
| 17.32-17.65 | 5.11-5.02 | vw | b |
| 18.24-18.46 | 4.86-4.80 | vw | b |
| 18.66-18.86 | 4.75-4.70 | vw | b |
| 19.59-19.80 | 4.53-4.48 | vw-w | s |
| 20.12-20.33 | 4.41-4.36 | vw-w | s |
| 20.70-20.89 | 4.29-4.25 | vw-w | s |
| 21.19-21.40 | 4.19-4.15 | vw-w | b |
| 21.88-22.05 | 4.06-4.03 | vw-w | b |
| 22.18-22.34 | 4.00-3.98 | vw-w | b |
| 22.41-22.58 | 3.96-3.93 | vw-w | b |
| 22.82-23.14 | 3.89-3.84 | vw-w | b, sh |
| 23.95-24.16 | 3.71-3.68 | vw-w | b |
| 25.16-25.37 | 3.54-3.51 | vw | b |
| 26.10-26.45 | 3.41-3.37 | vw | b |
| 26.94-27.12 | 3.31-3.28 | vw-w | s |
| 28.02-28.29 | 3.18-3.15 | vw | b |
| 29.00-29.23 | 3.08-3.05 | vw | b |
| 29.52-29.86 | 3.02-2.99 | vw | b |
| 30.40-30.62 | 2.94-2.92 | vw | s |
| 31.68-31.90 | 2.82-2.80 | vw | b |
| 32.54-32.78 | 2.75-2.73 | vw | b |
| 33.43-33.63 | 2.68-2.66 | vw | b |
| 34.56-34.80 | 2.59-2.58 | vw | b |
| 35.22-35.45 | 2.54-2.53 | vw | b |
| 36.51-36.77 | 2.46-2.44 | vw | b |
| 37.78-38.13 | 2.38-2.36 | vw | b |
| 38.58-38.82 | 2.33-2.32 | vw | b |
| 39.52-39.89 | 2.28-2.26 | vw | b |
| 40.65-40.85 | 2.22-2.21 | vw | b |
| 42.04-42.36 | 2.15-2.13 | vw | b |
| 42.55-43.13 | 2.12-2.10 | vw | b |
| 45.68-45.94 | 1.98-1.97 | vw | b |
| 49.24-49.60 | 1.85-1.84 | vw-w | b |
| 50.97-51.19 | 1.79-1.78 | vw | b |

These compositions may be used to adsorb PFAS substances. Their uses include catalyst supports and ion exchange materials.

### DETAILED DESCRIPTION OF THE INVENTION

A layered aluminoborate material is provided using nitrate in the absence of chloride that produces a unique diffraction pattern from those previously described in the literature. The as-synthesized material form of this material can be expressed by the empirical formula:

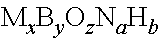

where M is a trivalent framework element such as aluminum or gallium, B is boron, O is oxygen, N is nitrogen and H is hydrogen and x is 3-8, y is 1-5, z is 16-25, a is 1 and b is 10-15.

Synthesis of the reported layered aluminoborate material often relies on chlorides with it being presumed that the chloride is incorporated into the structure and sits in between the layers of the materials. The present invention describes materials made using nitrate anions rather than chloride anions.

The reaction mixture containing reactive sources of the desired components can be described in terms of the molar rations of the oxides by the formula

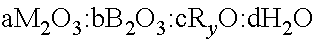

where “a” has a value of about 0.5 to 12, “b” has a value of about 1 to 36, “c” has a value of about 0.5 to 5, and “d” has a value from 30 to 1000. In this example R could be either an alkali or an alkaline earth element and the value of y is either 2 or 1, respectively.

The reaction mixture is reacted at a temperature of about 60° C. to about 200° C. and preferably from 150° C. to about 180° C. for a period of about 1 day to about 21 days and preferably for a time of about 3 days to about 10 days in a sealed reaction vessel at autogenous pressure. The reaction vessel may be heated with stirring, heating while tumbling, or heated statically. Once the crystallization is complete, the solid product is isolated from the mixture by means such as filtration or centrifugation and then washed with deionized water and dried in air at ambient temperature up to 100° C.

The NA-1 nitrate aluminoborate material, which is obtained from the above-described process, is characterized by the x-ray diffraction having at least the d-spacings and relative intensities set forth in Table 1:

TABLE 1

| Position 2θ (°) | d-spacing (Å) | Intensity | Comment |
|---|---|---|---|
| 6.67-6.85 | 13.23-12.89 | w | b-s, sh |
| 7.25-7.47 | 12.18-11.82 | m | b |
| 8.60-8.92 | 10.27-9.91 | vs | b |
| 14.23-14.46 | 6.22-6.12 | w | b |
| 16.62-16.81 | 5.33-5.27 | vw | s |
| 17.32-17.65 | 5.11-5.02 | vw | b |
| 18.24-18.46 | 4.86-4.80 | vw | b |
| 18.66-18.86 | 4.75-4.70 | vw | b |
| 19.59-19.80 | 4.53-4.48 | vw-w | s |
| 20.12-20.33 | 4.41-4.36 | vw-w | s |
| 20.70-20.89 | 4.29-4.25 | vw-w | s |
| 21.19-21.40 | 4.19-4.15 | vw-w | b |
| 21.88-22.05 | 4.06-4.03 | vw-w | b |
| 22.18-22.34 | 4.00-3.98 | vw-w | b |
| 22.41-22.58 | 3.96-3.93 | vw-w | b |
| 22.82-23.14 | 3.89-3.84 | vw-w | b, sh |
| 23.95-24.16 | 3.71-3.68 | vw-w | b |
| 25.16-25.37 | 3.54-3.51 | vw | b |
| 26.10-26.45 | 3.41-3.37 | vw | b |
| 26.94-27.12 | 3.31-3.28 | vw-w | s |
| 28.02-28.29 | 3.18-3.15 | vw | b |
| 29.00-29.23 | 3.08-3.05 | vw | b |
| 29.52-29.86 | 3.02-2.99 | vw | b |
| 30.40-30.62 | 2.94-2.92 | vw | s |
| 31.68-31.90 | 2.82-2.80 | vw | b |
| 32.54-32.78 | 2.75-2.73 | vw | b |
| 33.43-33.63 | 2.68-2.66 | vw | b |
| 34.56-34.80 | 2.59-2.58 | vw | b |
| 35.22-35.45 | 2.54-2.53 | vw | b |
| 36.51-36.77 | 2.46-2.44 | vw | b |
| 37.78-38.13 | 2.38-2.36 | vw | b |
| 38.58-38.82 | 2.33-2.32 | vw | b |
| 39.52-39.89 | 2.28-2.26 | vw | b |
| 40.65-40.85 | 2.22-2.21 | vw | b |
| 42.04-42.36 | 2.15-2.13 | vw | b |
| 42.55-43.13 | 2.12-2.10 | vw | b |
| 45.68-45.94 | 1.98-1.97 | vw | b |
| 49.24-49.60 | 1.85-1.84 | vw-w | b |
| 50.97-51.19 | 1.79-1.78 | vw | b |

The diffraction pattern of the NA-1 composition of this invention was obtained using standard x-ray powder diffraction techniques. The radiation source was a high-intensity, x-ray tube operated at 40 kV and 35 mA. Using copper K-alpha radiation was obtained by appropriate computer-based techniques. Flat compressed powder samples were continuously scanned from at least 3° to at least 560 2θ. Interplanar spacings (d) in Angstrom units were obtained from the position of the diffraction peaks expressed as θ where θ is the Bragg angle as observed from digitized data. Intensities were determined from the relative height of the diffraction peaks after the background which was obtained using a Chebychev polynomial fit. The intensity of the strongest line or peak was designated “I₀” and the intensity of each of the other peaks were designated as “I”.

As will be understood by those skilled in the art, the determination of the parameter 20 is subject to both human and mechanical error, which in combination can impose an uncertainty of about ±5% on each reported value of 2θ. This uncertainty is, of course, also manifested in the reported values of the d-spacings, which are calculated from the 2θ values. This imprecision is general throughout the art and is not sufficient to preclude the differentiation of the present crystalline materials from each other and from the compositions of the prior art. In some of the x-ray patterns reported, the relative intensities of the d-spacings are indicated by the notations vs, s, m, w, and vw which represent very strong, strong, medium, weak, and very weak respectively. In terms of 100×I/Iₒ, the above designations are defined as:

$$vw = 0 - 5 ; w = 5 - 15 ; m = 15 - 40 : s = 40 - 75 and vs = 75 - 100$$

As will be understood by those skilled in the art, the diffraction pattern of a layered material typically observes peaks that are both broad and sharp in nature. Broad peaks can complicate a diffraction pattern and where one peak is observed, multiple could be present and overlapping. Diffraction peaks are described in Table 1 as being either sharp (s) or broad (b) in nature. Where applicable, some peaks are described as a shoulder (sh) which is displayed off one of the peaks.

To more fully illustrate the invention, the following examples are set forth. It is to be understood that the examples are only by way of illustration and are not intended as an undue limitation on the broad scope of the invention as set forth in the appended claims.

### EXAMPLES

Examples 1-7 are aluminoborates that fall under the x-ray diffraction patterns of Table 1. These aluminoborates are prepared using Al(NO₃)₃.

### Example 1

In a typical reaction, the following gel formula was used 1 Al₂O₃: 3 B₂O₃: 1.75 Na₂O: 200 H₂O. A total of 68.16 g of water was weighed with 60.18 g added directly to the reaction beaker and 8 g of the water kept as a rinsing solution. The beaker was then allowed to start heating to ~70° C. and 17.05 g Al(NO₃)₃·9H₂O was added to the water. This was followed by 8.43 g H₃BO₃. After all the boric acid dissolved (~63° C.), 6.4 g 50% NaOH solution is added dropwise to adjust the pH between 2-2.8. The solution is stirred at about 70° C. for approximately 15 minutes, until it once again becomes clear and colorless and it was then transferred to Teflon lined autoclaves and reacted under autogenous pressure at 170° C. for 5 days. Once autoclaves were cooled, the sample was centrifuged to remove the mother liquor followed by 3 water washes and was dried in an oven at 90° C. The x-ray diffraction pattern for this material is found in Table 2.

TABLE 2

| Position 2θ (°) | d-spacing (Å) | Intensity |
|---|---|---|
| 6.80 | 12.98 | w |
| 7.42 | 11.90 | m |
| 8.87 | 9.96 | vs |
| 14.41 | 6.14 | w |
| 16.76 | 5.28 | vw |
| 17.60 | 5.03 | vw |
| 18.40 | 4.82 | vw |
| 18.81 | 4.71 | vw |
| 19.75 | 4.49 | w |
| 20.28 | 4.37 | w |
| 20.84 | 4.26 | w |
| 21.35 | 4.16 | w |
| 21.96 | 4.04 | w |
| 22.25 | 3.99 | w |
| 22.53 | 3.94 | w |
| 22.97 | 3.87 | w |
| 24.07 | 3.69 | w |
| 25.30 | 3.52 | vw |
| 26.40 | 3.37 | vw |
| 27.07 | 3.29 | w |
| 28.24 | 3.16 | vw |
| 29.17 | 3.06 | vw |
| 29.81 | 2.99 | vw |
| 30.57 | 2.92 | vw |
| 31.85 | 2.81 | vw |
| 32.72 | 2.73 | vw |
| 33.58 | 2.67 | vw |
| 34.75 | 2.58 | vw |
| 35.40 | 2.53 | vw |
| 36.72 | 2.44 | vw |
| 38.08 | 2.36 | vw |
| 38.77 | 2.32 | vw |
| 39.84 | 2.26 | vw |
| 40.78 | 2.21 | vw |
| 42.30 | 2.13 | vw |
| 42.87 | 2.11 | vw |
| 45.89 | 1.97 | vw |
| 49.50 | 1.84 | vw |
| 51.13 | 1.78 | vw |

### Example 2

In a typical reaction, the following gel formula was used 1 Al₂O₃: 3 B₂O₃: 1.75 Na₂O: 200 H₂O. A total of 68.00 g of water was weighed with 58.00 g added directly to the reaction beaker and 10 g of the water was kept as a rinsing solution. The beaker was then allowed to start heating to ~70° C. and 17.05 g Al(NO₃)₃·9H₂O is added to the water. This was followed by 8.43 g H₃BO₃. After all the boric acid dissolves (~63° C.), 6.4 g 50% NaOH solution was added dropwise to adjust the pH between 2-2.8. The solution was stirred at ~70° C. for approximately 15 minutes, until it once again becomes clear and colorless and was then transferred to Teflon lined autoclaves and reacted under autogenous pressure at 170° C. for 5 days. Once autoclaves were cooled, the sample was centrifuged to remove the mother liquor followed by 3 water washes and dried in an oven at 90° C. The x-ray diffraction pattern for this material is found in Table 3.

TABLE 3

| Position 2θ (°) | d-spacing (Å) | Intensity |
|---|---|---|
| 6.73 | 13.12 | w |
| 7.36 | 12.00 | m |
| 8.68 | 10.17 | vs |
| 14.30 | 6.18 | w |
| 16.67 | 5.31 | vw |
| 17.42 | 5.09 | vw |
| 18.32 | 4.84 | vw |
| 18.77 | 4.72 | vw |
| 19.65 | 4.51 | vw |
| 20.17 | 4.40 | w |
| 20.75 | 4.28 | w |
| 21.25 | 4.18 | w |
| 21.94 | 4.05 | w |
| 22.24 | 3.99 | w |
| 22.53 | 3.94 | w |
| 22.89 | 3.88 | w |
| 24.03 | 3.70 | vw |
| 25.21 | 3.53 | vw |
| 26.20 | 3.40 | vw |
| 26.99 | 3.30 | vw |
| 28.10 | 3.17 | vw |
| 29.06 | 3.07 | vw |
| 29.65 | 3.01 | vw |
| 30.46 | 2.93 | vw |
| 31.73 | 2.82 | vw |
| 32.59 | 2.74 | vw |
| 33.48 | 2.67 | vw |
| 34.65 | 2.59 | vw |
| 35.27 | 2.54 | vw |
| 36.58 | 2.45 | vw |
| 37.97 | 2.37 | vw |
| 38.63 | 2.33 | vw |
| 39.71 | 2.27 | vw |
| 40.77 | 2.21 | vw |
| 42.22 | 2.14 | vw |
| 42.60 | 2.12 | vw |
| 45.79 | 1.98 | vw |
| 49.38 | 1.84 | vw |
| 51.02 | 1.79 | vw |

### Example 3

In a typical reaction, the following gel formula was used 1 Al₂O₃: 3 B₂O₃: 1.75 Na₂O: 200 H₂O. A total of 136.42 g of water was weighed and approximately 10 g of the water was kept as a rinsing solution. The beaker was then allowed to start heating to ~70° C. and 34.11 g Al(NO₃)₃·9H₂O was added to the water. This was followed by 16.9 g H₃BO₃. After all the boric acid dissolves, 12.72 g 50% NaOH solution was added dropwise to adjust the pH between 2-2.8. The solution was stirred at ~70° C. for approximately 15 minutes, until it once again became clear and colorless and was then transferred to Teflon lined autoclaves and reacted under autogenous pressure at 160° C. for 5 days. Once autoclaves were cooled, the sample was centrifuged to remove the mother liquor followed by 3 water washes and was dried in an oven at 90° C. The x-ray diffraction pattern for this material is found in Table 4.

TABLE 4

| Position 2θ (°) | d-spacing (Å) | Intensity |
|---|---|---|
| 6.72 | 13.14 | w |
| 7.30 | 12.09 | m |
| 8.65 | 10.21 | vs |
| 14.30 | 6.19 | w |
| 16.68 | 5.31 | vw |
| 17.38 | 5.10 | vw |
| 18.29 | 4.85 | vw |
| 18.79 | 4.72 | vw |
| 19.64 | 4.51 | w |
| 20.17 | 4.40 | w |
| 20.76 | 4.27 | w |
| 21.26 | 4.17 | w |
| 21.94 | 4.05 | w |
| 22.24 | 3.99 | w |
| 22.46 | 3.95 | w |
| 22.87 | 3.88 | w |
| 24.05 | 3.70 | vw |
| 25.22 | 3.53 | vw |
| 26.15 | 3.40 | vw |
| 27.01 | 3.30 | vw |
| 28.07 | 3.18 | vw |
| 29.05 | 3.07 | vw |
| 29.73 | 3.00 | vw |
| 30.45 | 2.93 | vw |
| 31.73 | 2.82 | vw |
| 32.67 | 2.74 | vw |
| 33.48 | 2.67 | vw |
| 34.61 | 2.59 | vw |
| 35.35 | 2.54 | vw |
| 36.56 | 2.45 | vw |
| 37.92 | 2.37 | vw |
| 38.75 | 2.32 | vw |
| 39.70 | 2.27 | vw |
| 40.70 | 2.21 | vw |
| 42.09 | 2.14 | vw |
| 42.69 | 2.12 | vw |
| 45.84 | 1.98 | vw |
| 49.47 | 1.84 | vw |
| 51.09 | 1.79 | vw |

### Example 5

In a typical reaction, the following gel formula was used 1 Al₂O₃: 3 B₂O₃: 1.75 Na₂O: 200 H₂O. A total of 272.72 g of water was weighed and approximately 10 g of the water was kept as a rinsing solution. The beaker was then allowed to start heating to ~70° C. and 68.18 g Al(NO₃)₃·9H₂O was added to the water. This was followed by 33.73 g H₃BO₃. After all the boric acid dissolved, 25.46 g 50% NaOH solution was added dropwise to adjust the pH between 2-2.8. The solution was stirred at ~70° C. for approximately 15 minutes, until it once again became clear and colorless and was then transferred to Teflon lined autoclaves and reacted under autogenous pressure at 170° C. for 5 days. Once autoclaves were cooled, the sample was centrifuged to remove the mother liquor followed by 3 water washes and was dried in an oven at 90° C. The x-ray diffraction pattern for this material is found in Table 5.

TABLE 5

| Position 2θ (°) | d-spacing (Å) | Intensity |
|---|---|---|
| 6.80 | 12.99 | w |
| 7.36 | 12.00 | m |
| 8.68 | 10.18 | vs |
| 14.31 | 6.18 | w |
| 16.69 | 5.31 | vw |
| 17.37 | 5.10 | vw |
| 18.41 | 4.81 | vw |
| 18.80 | 4.71 | vw |
| 19.67 | 4.51 | vw |
| 20.17 | 4.40 | vw |
| 20.76 | 4.27 | vw |
| 21.24 | 4.18 | vw |
| 21.93 | 4.05 | vw |
| 22.23 | 3.99 | vw |
| 22.52 | 3.94 | vw |
| 22.96 | 3.87 | vw |
| 24.09 | 3.69 | vw |
| 25.29 | 3.52 | vw |
| 26.40 | 3.37 | vw |
| 27.02 | 3.30 | vw |
| 28.22 | 3.16 | vw |
| 29.18 | 3.06 | vw |
| 29.57 | 3.02 | vw |
| 30.47 | 2.93 | vw |
| 31.73 | 2.82 | vw |
| 32.71 | 2.73 | vw |
| 33.48 | 2.67 | vw |
| 34.68 | 2.58 | vw |
| 35.39 | 2.53 | vw |
| 36.71 | 2.45 | vw |
| 38.07 | 2.36 | vw |
| 38.75 | 2.32 | vw |
| 39.82 | 2.26 | vw |
| 40.75 | 2.21 | vw |
| 42.27 | 2.14 | vw |
| 42.91 | 2.11 | vw |
| 45.87 | 1.98 | vw |
| 49.39 | 1.84 | w |
| 51.14 | 1.78 | vw |

### Example 5

In a typical reaction, the following gel formula was used 1 Al₂O₃: 3 B₂O₃: 1.75 Na₂O: 180 H₂O. A total of 130.66 g of water was weighed and approximately 10 g of the water was kept as a rinsing solution. The beaker was then allowed to start heating to about 70° C. and 37.18 g Al(NO₃)₃·9H₂O was added to the water. This was followed by 18.39 g H₃BO₃. After all the boric acid dissolved, 13.89 g 50% NaOH solution was added dropwise to adjust the pH between 2-2.8. The solution was stirred at ~70° C. for approximately 15 minutes, until it once again became clear and colorless and was then transferred to Teflon lined autoclaves and reacted under autogenous pressure at 170° C. for 5 days. Once autoclaves were cooled, the sample was centrifuged to remove the mother liquor followed by 3 water washes and was dried in an oven at 90° C. The x-ray diffraction pattern for this material is found in Table 6.

TABLE 6

| Position 2θ (°) | d-spacing (Å) | Intensity |
|---|---|---|
| 6.74 | 12.99 | w |
| 7.33 | 12.00 | m |
| 8.69 | 10.18 | vs |
| 14.28 | 6.18 | w |
| 16.68 | 5.31 | vw |
| 17.46 | 5.10 | vw |
| 18.37 | 4.81 | vw |
| 18.71 | 4.71 | vw |
| 19.68 | 4.51 | vw |
| 20.19 | 4.40 | vw |
| 20.75 | 4.27 | vw |
| 21.27 | 4.18 | vw |
| 21.97 | 4.05 | vw |
| 22.29 | 3.99 | vw |
| 22.49 | 3.94 | vw |
| 23.05 | 3.87 | vw |
| 24.00 | 3.69 | vw |
| 25.28 | 3.52 | vw |
| 26.16 | 3.37 | vw |
| 27.00 | 3.30 | vw |
| 28.12 | 3.16 | vw |
| 29.13 | 3.06 | vw |
| 29.69 | 3.02 | vw |
| 30.51 | 2.93 | vw |
| 31.76 | 2.82 | vw |
| 32.61 | 2.73 | vw |
| 33.52 | 2.67 | vw |
| 34.62 | 2.58 | vw |
| 35.31 | 2.53 | vw |
| 36.60 | 2.45 | vw |
| 37.95 | 2.36 | vw |
| 38.67 | 2.32 | vw |
| 39.57 | 2.26 | vw |
| 40.80 | 2.21 | vw |
| 42.24 | 2.14 | vw |
| 42.75 | 2.11 | vw |
| 45.76 | 1.98 | vw |
| 49.55 | 1.84 | w |
| 51.09 | 1.78 | vw |

### Example 6

In a typical reaction, the following gel formula was used: 0.9 Al₂O₃: 0.1MgO: 3 B₂O₃: 1.75 Na₂O: 200 H₂O. A total of 138.13 g of water was weighed and approximately 10 g of the water was kept as a rinsing solution. The beaker was then allowed to start heating to ~70° C. and 30.94 g Al(NO₃)₃·9H₂O was added to the water followed by 1.15 g Mg(NO₃)₂·6H₂O. This is followed by 16.99 g H₃BO₃. After all the boric acid dissolves, 12.85 g 50% NaOH solution was added dropwise to adjust the Ph between 2-2.8. The solution was stirred at about 70° C. for approximately 15 minutes, until it once again becomes clear and colorless and is then transferred to Teflon lined autoclaves and reacted under autogenous pressure at 170° C. for 5 days. Once autoclaves are cooled, the sample is centrifuged to remove the mother liquor followed by 3 water washes and is dried in an oven at 90° C. The x-ray diffraction pattern for this material is found in Table 7.

TABLE 7

| Position 2θ (°) | d-spacing (Å) | Intensity |
|---|---|---|
| 6.74 | 13.10 | w |
| 7.35 | 12.01 | m |
| 8.69 | 10.17 | vs |
| 14.30 | 6.19 | w |
| 16.70 | 5.30 | vw |
| 17.42 | 5.08 | vw |
| 18.32 | 4.84 | vw |
| 18.81 | 4.71 | vw |
| 19.68 | 4.51 | vw |
| 20.20 | 4.39 | vw |
| 20.79 | 4.27 | w |
| 21.28 | 4.17 | w |
| 22.00 | 4.03 | w |
| 22.26 | 3.99 | vw |
| 22.48 | 3.95 | vw |
| 22.97 | 3.87 | vw |
| 24.11 | 3.69 | vw |
| 25.32 | 3.51 | vw |
| 26.18 | 3.40 | vw |
| 27.01 | 3.30 | vw |
| 28.09 | 3.17 | vw |
| 29.09 | 3.07 | vw |
| 29.72 | 3.00 | vw |
| 30.52 | 2.93 | vw |
| 31.76 | 2.81 | vw |
| 32.73 | 2.73 | vw |
| 33.53 | 2.67 | vw |
| 34.68 | 2.58 | vw |
| 35.35 | 2.54 | vw |
| 36.66 | 2.45 | vw |
| 37.94 | 2.37 | vw |
| 38.74 | 2.32 | vw |
| 39.78 | 2.26 | vw |
| 40.74 | 2.21 | vw |
| 42.31 | 2.13 | vw |
| 42.92 | 2.10 | vw |
| 45.88 | 1.98 | vw |
| 49.29 | 1.85 | vw |
| 51.13 | 1.78 | vw |

### Example 7

In a typical reaction, the following gel formula is used: 1 Al₂O₃: 3 B₂O₃: 2 Na₂O: 200 H₂O. A total of 134.84 g of water was weighed and approximately 10 g of the water was kept as a rinsing solution. The beaker was then allowed to start heating to ~70° C. and 34.00 g Al(NO₃)₃·9H₂O was added to the water. This was followed by 16.84 g H₃BO₃. After all the boric acid dissolved, 14.55 g 50% NaOH solution was added dropwise to adjust the pH between 2-2.8. The solution was stirred at about 70° C. for approximately 15 minutes, until it once again became clear and colorless and then transferred to Teflon lined autoclaves and reacted under autogenous pressure at 170° C. for 5 days. Once autoclaves were cooled, the sample was centrifuged to remove the mother liquor followed by 3 water washes and was dried in an oven at 90° C. The x-ray diffraction pattern for this material is found in Table 8.

TABLE 8

| Position 2θ (°) | d-spacing (Å) | Intensity |
|---|---|---|
| 6.74 | 13.00 | w |
| 7.35 | 11.96 | m |
| 8.69 | 10.14 | vs |
| 14.30 | 6.18 | w |
| 16.70 | 5.30 | vw |
| 17.42 | 5.07 | vw |
| 18.33 | 4.84 | vw |
| 18.81 | 4.73 | vw |
| 19.68 | 4.51 | vw |
| 20.20 | 4.39 | w |
| 20.79 | 4.27 | w |
| 21.28 | 4.17 | w |
| 22.00 | 4.04 | w |
| 22.26 | 3.99 | w |
| 22.48 | 3.95 | w |
| 22.97 | 3.85 | vw |
| 24.11 | 3.70 | vw |
| 25.32 | 3.53 | vw |
| 26.18 | 3.40 | vw |
| 27.01 | 3.30 | vw |
| 28.09 | 3.17 | vw |
| 29.09 | 3.07 | vw |
| 29.72 | 3.00 | vw |
| 30.52 | 2.93 | vw |
| 31.76 | 2.82 | vw |
| 32.73 | 2.74 | vw |
| 33.53 | 2.67 | vw |
| 34.68 | 2.58 | vw |
| 35.35 | 2.54 | vw |
| 36.66 | 2.45 | vw |
| 37.94 | 2.38 | vw |
| 38.74 | 2.32 | vw |
| 39.78 | 2.27 | vw |
| 40.74 | 2.21 | vw |
| 42.31 | 2.14 | vw |
| 42.92 | 2.10 | vw |
| 45.88 | 1.98 | vw |
| 49.29 | 1.84 | vw |
| 51.13 | 1.79 | vw |

Table 9 summarizes the compositions for the listed examples.

TABLE 9

| Sample | Al ICP | B ICP | N (CHN) | H (CHN) |
|---|---|---|---|---|
| Example 1 | 25.0 | 5.5 | 2.53 | 2.58 |
| Example 7 | 22.2 | 4.8 | 2.52 | 2.63 |
| Example 6 (w/Mg | 19.9 | 4.7 | 3.06 | 2.56 |
| in gel) | | | | |
| Example 4 | 27.8 | 2.4 | 2.72 | 2.26 |
| Example 3 | 22.7 | 5.5 | 3.24 | 2.37 |

Table 10 shows the effectiveness of the materials of the aluminoborate materials in removing PFOA from brine as compared to a prior art method.

TABLE 10
PFOA + Brine (NaOH + NaF)-QQQ-LS-MS Results
0.1 g/100 mL (L/S=1000) of PFOA + Brine solution (77 ppm
PFOA-#37117-89)/24 hrs at RT

| | | Parent Sol | | % adsorb |
|---|---|---|---|---|
| KH #/Reference Materials | pH F | PFOA ppb | ppb PFOA | PFOA |
| Example 2 | 5.14 | 58.9 | 4.04 | 93.14 |
| Carbon GC 12X40 mesh | 8.76 | 58.9 | 7.88 | 86.62 |

### PFOA Solution Preparation

In a 2-Liter Nalgene bottle the 1^{st} PFOA solution was prepared by dissolving 0.5 grams of PFOA (Perfluorooctanoic Acid; 95%) in 1 liter of Milli Q deionized water, this solution was placed on a shaker table for 24 hours to dissolve the PFOA solid (398 ppm Fluoride in the solution). Next, the second solution was made by removing 100 mL of Solution #1 and placed in a 2-Liter Nalgene bottle along with 900 mL of Milli Q deionized water (75 ppb of PFOA-#37117-80).

### PFOA+ Brine Solution

Next, the third solution was made by taking 500-mL of solution #2 (75 ppb PFOA) and Dissolve 0.007 grams of Sodium Fluoride and 0.007 grams (58.9 PPB PFOA)

### Test Protocol Method

0.15 grams of fine powder material (Ex 2)(adjusted assuming LOI ~40%-0.1 grams) was added to a 250-mL HDPE plastic bottle along with 100 mL of the above PFOA+ Brine and 0.1 grams of GC Carbon (reference) was also added to a 250-mL HDPE plastic bottle along with 100 mL of the above PFOA+ Brine added both were placed on a shaker table (VWR® Advanced Orbital Shakers, Model 15000) at room temperature at 150 RPM to maintain uniformity in the mixing and adsorption process for 24 hours. Next, 15-mL of solution is removed with a syringe-driven filter (Whatman Pura disc 25 mm filter) and then submitted for QQQ-LS-MS.

### Comparative Example 1

In a typical reaction, the following gel formula is used: 1 Al₂O₃: 3 B₂O₃: 1.75 Na₂O: 200 H₂O. A total of 36.62 g of water is weighed and approximately 3 g of the water was kept as a rinsing solution. The beaker is then allowed to start heating to ~70° C. and 5.70 g Al(Cl)₃·9H₂O is added to the water. This is followed by 4.37 g H₃BO₃. After all the boric acid dissolves, 3.30 g 50% NaOH solution is added dropwise to adjust the pH between 2-2.8. The solution is stirred at about 70° C. for approximately 15 minutes, until it once again becomes clear and colorless and is then transferred to Teflon lined autoclaves and reacted under autogenous pressure at 170° C. for 5 days. Once autoclaves are cooled, the sample is centrifuged to remove the mother liquor followed by 3 water washes and is dried in an oven at 90° C.

### Comparative Example 2

In a typical reaction, the following gel formula is used: 0.75 Al₂O₃: 6 B₂O₃: 1.75 Na₂O: 200 H2O. A total of 135.12 g of water is weighed and approximately 9.5 g of the water was kept as a rinsing solution. The beaker is then allowed to start heating to about 70° C. and 16.56 g Al(Cl)₃·9H2O is added to the water. This is followed by 33.83 g H₃BO₃. After all the boric acid dissolves, 14.65 g 50% NaOH solution is added dropwise to adjust the pH between 2-2.8. The solution is stirred at about 70° C. for approximately 15 minutes, until it once again becomes clear and colorless and is then transferred to Teflon lined autoclaves and reacted under autogenous pressure at 170° C. for 5 days. Once autoclaves are cooled, the sample is centrifuged to remove the mother liquor followed by 3 water washes and is dried in an oven at 90° C.

### SPECIFIC EMBODIMENTS

While the following is described in conjunction with specific embodiments, it will be understood that this description is intended to illustrate and not limit the scope of the preceding description and the appended claims.

A first embodiment of the invention is a composition comprising an empirical formula MₓB_{y}O_{z}NₐH_{b} where M is a trivalent framework element, B is boron, O is oxygen, N is nitrogen and H is hydrogen x is 3-8, y is 1-5, z is 16-25, a is 1 and b is 10-15, wherein the composition is characterized by an x-ray diffraction having at least the d-spacings and relative spacings set forth in Table 1,

TABLE 1

| Position 2θ (°) | d-spacing (Å) | Intensity | Comment |
|---|---|---|---|
| 6.67-6.85 | 13.23-12.89 | w | b-s, sh |
| 7.25-7.47 | 12.18-11.82 | m | b |
| 8.60-8.92 | 10.27-9.91 | vs | b |
| 14.23-14.46 | 6.22-6.12 | w | b |
| 16.62-16.81 | 5.33-5.27 | vw | s |
| 17.32-17.65 | 5.11-5.02 | vw | b |
| 18.24-18.46 | 4.86-4.80 | vw | b |
| 18.66-18.86 | 4.75-4.70 | vw | b |
| 19.59-19.80 | 4.53-4.48 | vw-w | s |
| 20.12-20.33 | 4.41-4.36 | vw-w | s |
| 20.70-20.89 | 4.29-4.25 | vw-w | s |
| 21.19-21.40 | 4.19-4.15 | vw-w | b |
| 21.88-22.05 | 4.06-4.03 | vw-w | b |
| 22.18-22.34 | 4.00-3.98 | vw-w | b |
| 22.41-22.58 | 3.96-3.93 | vw-w | b |
| 22.82-23.14 | 3.89-3.84 | vw-w | b, sh |
| 23.95-24.16 | 3.71-3.68 | vw-w | b |
| 25.16-25.37 | 3.54-3.51 | vw | b |
| 26.10-26.45 | 3.41-3.37 | vw | b |
| 26.94-27.12 | 3.31-3.28 | vw-w | s |
| 28.02-28.29 | 3.18-3.15 | vw | b |
| 29.00-29.23 | 3.08-3.05 | vw | b |
| 29.52-29.86 | 3.02-2.99 | vw | b |
| 30.40-30.62 | 2.94-2.92 | vw | s |
| 31.68-31.90 | 2.82-2.80 | vw | b |
| 32.54-32.78 | 2.75-2.73 | vw | b |
| 33.43-33.63 | 2.68-2.66 | vw | b |
| 34.56-34.80 | 2.59-2.58 | vw | b |
| 35.22-35.45 | 2.54-2.53 | vw | b |
| 36.51-36.77 | 2.46-2.44 | vw | b |
| 37.78-38.13 | 2.38-2.36 | vw | b |
| 38.58-38.82 | 2.33-2.32 | vw | b |
| 39.52-39.89 | 2.28-2.26 | vw | b |
| 40.65-40.85 | 2.22-2.21 | vw | b |
| 42.04-42.36 | 2.15-2.13 | vw | b |
| 42.55-43.13 | 2.12-2.10 | vw | b |
| 45.68-45.94 | 1.98-1.97 | vw | b |
| 49.24-49.60 | 1.85-1.84 | vw-w | b |
| 50.97-51.19 | 1.79-1.78 | vw | b |

An embodiment of the invention is one, any or al of prior embodiments in this paragraph up through the first embodiment in this paragraph wherein M is aluminum or gallium. An embodiment of the invention is one, any or all of prior embodiments in this paragraph up through the first embodiment in this paragraph produced from a reaction mixture comprising oxides in molar ratios having a formula aM₂O₃ bB₂O₃ cR_{y}O dH₂O where “a” has a value of about 0.5 to 12, “b” has a value of about 1 to 36, “c” has a value of about 0.5 to 5, and “d” has a value from 30 to 1000.

A second embodiment of the invention is a method of making a composition having a formula MₓB_{y}O_{z}NₐH_{b} where M is a trivalent framework element, B is boron, O is oxygen, N is nitrogen and 1-1 is hydrogen, the process comprising mixing oxides and water to form a reaction mixture aM₂O₃bB₂O₃ cR_{y}O dH₂O where “a” has a value of about 0.5 to 12, “b” has a value of about 1 to 36, “c” has a value of about 0.5 to 5, and “d” has a value from 30 to 1000 and “y” is 2 or 1; heating the reaction mixture at a temperature of about 60° C. to about 200° C. and isolating a solid product after crystallization is complete. An embodiment of the invention is one, any or all of prior embodiments in this paragraph up through the second embodiment in this paragraph wherein R is sodium. An embodiment of the invention is one, any or all of prior embodiments in this paragraph up through the second embodiment in this paragraph wherein the reaction mixture is heated at a temperature from about 150° C. to about 180° C. An embodiment of the invention is one, any or all of prior embodiments in this paragraph up through the second embodiment in this paragraph wherein the reaction mixture is heated for a period of about 1 day to 21 days. An embodiment of the invention is one, any or all of prior embodiments in this paragraph up through the second embodiment in this paragraph wherein the reaction mixture is heated for a period of about 3 days to 10 days. An embodiment of the invention is one, any or all of prior embodiments in this paragraph up through the second embodiment in this paragraph wherein the solid product is isolated from the reaction mixture by filtration or centrifugation. An embodiment of the invention is one, any or all of prior embodiments in this paragraph up through the second embodiment in this paragraph wherein the solid product is washed with deionized water and dried in air at a temperature from ambient temperature to about 150° C. An embodiment of the invention is one, any or all of prior embodiments in this paragraph up through the second embodiment in this paragraph wherein the reaction mixture is heated with stirring, heated while tumbling or heated statically. An embodiment of the invention is one, any or all of prior embodiments in this paragraph up through the second embodiment in this paragraph wherein the reaction mixture is reacted in a sealed reaction vessel at autogenous pressure. An embodiment of the invention is one, any or all of prior embodiments in this paragraph up through the second embodiment in this paragraph wherein R is an alkali element or an alkaline earth element. An embodiment of the invention is one, any or all of prior embodiments in this paragraph up through the second embodiment in this paragraph wherein R is sodium.

A third embodiment of the invention is a process for removing per- and polyfluoroalkyl substances from water comprising contacting the water with a composition comprising an empirical formula MₓB_{y}O_{z}NₐH_{b} where M is a trivalent framework element, B is boron, O is oxygen, N is nitrogen and H is hydrogen and wherein x is 3-8, y is 1-5, z is 16-25, a is 1 and b is 10-15, wherein the composition is characterized by an x-ray diffraction having at least the d-spacings and relative spacings set forth in Table 1,

TABLE 1

| Position 2θ (°) | d-spacing (Å) | Intensity | Comment |
|---|---|---|---|
| 6.67-6.85 | 13.23-12.89 | w | b-s, sh |
| 7.25-7.47 | 12.18-11.82 | m | b |
| 8.60-8.92 | 10.27-9.91 | vs | b |
| 14.23-14.46 | 6.22-6.12 | w | b |
| 16.62-16.81 | 5.33-5.27 | vw | s |
| 17.32-17.65 | 5.11-5.02 | vw | b |
| 18.24-18.46 | 4.86-4.80 | vw | b |
| 18.66-18.86 | 4.75-4.70 | vw | b |
| 19.59-19.80 | 4.53-4.48 | vw-w | s |
| 20.12-20.33 | 4.41-4.36 | vw-w | s |
| 20.70-20.89 | 4.29-4.25 | vw-w | s |
| 21.19-21.40 | 4.19-4.15 | vw-w | b |
| 21.88-22.05 | 4.06-4.03 | vw-w | b |
| 22.18-22.34 | 4.00-3.98 | vw-w | b |
| 22.41-22.58 | 3.96-3.93 | vw-w | b |
| 22.82-23.14 | 3.89-3.84 | vw-w | b, sh |
| 23.95-24.16 | 3.71-3.68 | vw-w | b |
| 25.16-25.37 | 3.54-3.51 | vw | b |
| 26.10-26.45 | 3.41-3.37 | vw | b |
| 26.94-27.12 | 3.31-3.28 | vw-w | s |
| 28.02-28.29 | 3.18-3.15 | vw | b |
| 29.00-29.23 | 3.08-3.05 | vw | b |
| 29.52-29.86 | 3.02-2.99 | vw | b |
| 30.40-30.62 | 2.94-2.92 | vw | s |
| 31.68-31.90 | 2.82-2.80 | vw | b |
| 32.54-32.78 | 2.75-2.73 | vw | b |
| 33.43-33.63 | 2.68-2.66 | vw | b |
| 34.56-34.80 | 2.59-2.58 | vw | b |
| 35.22-35.45 | 2.54-2.53 | vw | b |
| 36.51-36.77 | 2.46-2.44 | vw | b |
| 37.78-38.13 | 2.38-2.36 | vw | b |
| 38.58-38.82 | 2.33-2.32 | vw | b |
| 39.52-39.89 | 2.28-2.26 | vw | b |
| 40.65-40.85 | 2.22-2.21 | vw | b |
| 42.04-42.36 | 2.15-2.13 | vw | b |
| 42.55-43.13 | 2.12-2.10 | vw | b |
| 45.68-45.94 | 1.98-1.97 | vw | b |
| 49.24-49.60 | 1.85-1.84 | vw-w | b |
| 50.97-51.19 | 1.79-1.78 | vw | b |

An embodiment of the invention is one, any or all of prior embodiments in this paragraph up through the third embodiment in this paragraph wherein M is aluminum or gallium. An embodiment of the invention is one, any or all of prior embodiments in this paragraph up through the third embodiment in this paragraph wherein the composition is produced from a reaction mixture comprising oxides in molar ratios having a formula aM₂O₃ bB₂O₃ cR_{y}O dH₂O where “a” has a value of about 0.5 to 12, “b” has a value of about 1 to 36, “c” has a value of about 0.5 to 5, and “d” has a value from 30 to 1000.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A composition comprising an empirical formula: 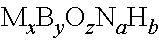
where M is a trivalent framework element, B is boron, O is oxygen, N is nitrogen and H is hydrogen, x is 3-8, y is 1-5, z is 16-25, a is 1 and b is 10-15, wherein said composition is characterized by an x-ray diffraction having at least the d-spacings and relative spacings set forth in Table 1:
TABLE 1

| Position 2θ (°) | d-spacing (Å) | Intensity | Comment |
|---|---|---|---|
| 6.67-6.85 | 13.23-12.89 | w | b-s, sh |
| 7.25-7.47 | 12.18-11.82 | m | b |
| 8.60-8.92 | 10.27-9.91 | vs | b |
| 14.23-14.46 | 6.22-6.12 | w | b |
| 16.62-16.81 | 5.33-5.27 | vw | s |
| 17.32-17.65 | 5.11-5.02 | vw | b |
| 18.24-18.46 | 4.86-4.80 | vw | b |
| 18.66-18.86 | 4.75-4.70 | vw | b |
| 19.59-19.80 | 4.53-4.48 | vw-w | s |
| 20.12-20.33 | 4.41-4.36 | vw-w | s |
| 20.70-20.89 | 4.29-4.25 | vw-w | s |
| 21.19-21.40 | 4.19-4.15 | vw-w | b |
| 21.88-22.05 | 4.06-4.03 | vw-w | b |
| 22.18-22.34 | 4.00-3.98 | vw-w | b |
| 22.41-22.58 | 3.96-3.93 | vw-w | b |
| 22.82-23.14 | 3.89-3.84 | vw-w | b, sh |
| 23.95-24.16 | 3.71-3.68 | vw-w | b |
| 25.16-25.37 | 3.54-3.51 | vw | b |
| 26.10-26.45 | 3.41-3.37 | vw | b |
| 26.94-27.12 | 3.31-3.28 | vw-w | s |
| 28.02-28.29 | 3.18-3.15 | vw | b |
| 29.00-29.23 | 3.08-3.05 | vw | b |
| 29.52-29.86 | 3.02-2.99 | vw | b |
| 30.40-30.62 | 2.94-2.92 | vw | s |
| 31.68-31.90 | 2.82-2.80 | vw | b |
| 32.54-32.78 | 2.75-2.73 | vw | b |
| 33.43-33.63 | 2.68-2.66 | vw | b |
| 34.56-34.80 | 2.59-2.58 | vw | b |
| 35.22-35.45 | 2.54-2.53 | vw | b |
| 36.51-36.77 | 2.46-2.44 | vw | b |
| 37.78-38.13 | 2.38-2.36 | vw | b |
| 38.58-38.82 | 2.33-2.32 | vw | b |
| 39.52-39.89 | 2.28-2.26 | vw | b |
| 40.65-40.85 | 2.22-2.21 | vw | b |
| 42.04-42.36 | 2.15-2.13 | vw | b |
| 42.55-43.13 | 2.12-2.10 | vw | b |
| 45.68-45.94 | 1.98-1.97 | vw | b |
| 49.24-49.60 | 1.85-1.84 | vw-w | b |
| 50.97-51.19 | 1.79-1.78 | vw | b |

2. The composition of claim 1 wherein M is aluminum or gallium.

3. The composition of claim 1 produced from a reaction mixture comprising oxides in molar ratios having a formula 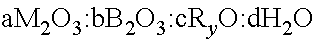
where “a” has a value of about 0.5 to 12, “b” has a value of about 1 to 36, “c” has a value of about 0.5 to 5, and “d” has a value from 30 to 1000.

4. A method of making a composition having a formula: 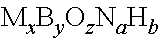
where M is a trivalent framework element, B is boron, O is oxygen, N is nitrogen and H is hydrogen, said process comprising mixing oxides and water to form a reaction mixture 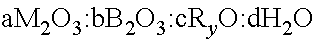
where “a” has a value of about 0.5 to 12, “b” has a value of about 1 to 36, “c” has a value of about 0.5 to 5, and “d” has a value from 30 to 1000 and “y” is 2 or 1; heating said reaction mixture at a temperature of about 60° C. to about 200° C. and isolating a solid product after crystallization is complete.

5. The method of claim 4 wherein R is sodium.

6. The method of claim 4 wherein said reaction mixture is heated at a temperature from about 150° C. to about 180° C.

7. The method of claim 4 wherein said reaction mixture is heated for a period of about 1 day to 21 days.

8. The method of claim 4 wherein said reaction mixture is heated for a period of about 3 days to 10 days.

9. The method of claim 4 wherein said solid product is isolated from said reaction mixture by filtration or centrifugation.

10. The method of claim 4 wherein said solid product is washed with deionized water and dried in air at a temperature from ambient temperature to about 150° C.

11. The method of claim 4 wherein said reaction mixture is heated with stirring, heated while tumbling or heated statically.

12. The method of claim 4 wherein said reaction mixture is reacted in a sealed reaction vessel at autogenous pressure.

13. The method of claim 4 wherein R is an alkali element or an alkaline earth element.

14. The method of claim 13 wherein R is sodium.

15. A process for removing per- and polyfluoroalkyl substances from water comprising contacting said water with a composition comprising an empirical formula: 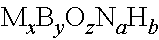
where M is a trivalent framework element, B is boron, O is oxygen, N is nitrogen and H is hydrogen and wherein x is 3-8, y is 1-5, z is 16-25, a is 1 and b is 10-15, wherein said composition is characterized by an x-ray diffraction having at least the d-spacings and relative spacings set forth in Table 1:
TABLE 1

| Position 2θ (°) | d-spacing (Å) | Intensity | Comment |
|---|---|---|---|
| 6.67-6.85 | 13.23-12.89 | w | b-s, sh |
| 7.25-7.47 | 12.18-11.82 | m | b |
| 8.60-8.92 | 10.27-9.91 | vs | b |
| 14.23-14.46 | 6.22-6.12 | w | b |
| 16.62-16.81 | 5.33-5.27 | vw | s |
| 17.32-17.65 | 5.11-5.02 | vw | b |
| 18.24-18.46 | 4.86-4.80 | vw | b |
| 18.66-18.86 | 4.75-4.70 | vw | b |
| 19.59-19.80 | 4.53-4.48 | vw-w | s |
| 20.12-20.33 | 4.41-4.36 | vw-w | s |
| 20.70-20.89 | 4.29-4.25 | vw-w | s |
| 21.19-21.40 | 4.19-4.15 | vw-w | b |
| 21.88-22.05 | 4.06-4.03 | vw-w | b |
| 22.18-22.34 | 4.00-3.98 | vw-w | b |
| 22.41-22.58 | 3.96-3.93 | vw-w | b |
| 22.82-23.14 | 3.89-3.84 | vw-w | b, sh |
| 23.95-24.16 | 3.71-3.68 | vw-w | b |
| 25.16-25.37 | 3.54-3.51 | vw | b |
| 26.10-26.45 | 3.41-3.37 | vw | b |
| 26.94-27.12 | 3.31-3.28 | vw-w | s |
| 28.02-28.29 | 3.18-3.15 | vw | b |
| 29.00-29.23 | 3.08-3.05 | vw | b |
| 29.52-29.86 | 3.02-2.99 | vw | b |
| 30.40-30.62 | 2.94-2.92 | vw | s |
| 31.68-31.90 | 2.82-2.80 | vw | b |
| 32.54-32.78 | 2.75-2.73 | vw | b |
| 33.43-33.63 | 2.68-2.66 | vw | b |
| 34.56-34.80 | 2.59-2.58 | vw | b |
| 35.22-35.45 | 2.54-2.53 | vw | b |
| 36.51-36.77 | 2.46-2.44 | vw | b |
| 37.78-38.13 | 2.38-2.36 | vw | b |
| 38.58-38.82 | 2.33-2.32 | vw | b |
| 39.52-39.89 | 2.28-2.26 | vw | b |
| 40.65-40.85 | 2.22-2.21 | vw | b |
| 42.04-42.36 | 2.15-2.13 | vw | b |
| 42.55-43.13 | 2.12-2.10 | vw | b |
| 45.68-45.94 | 1.98-1.97 | vw | b |
| 49.24-49.60 | 1.85-1.84 | vw-w | b |
| 50.97-51.19 | 1.79-1.78 | vw | b |

16. The process of claim 15 wherein M is aluminum or gallium.

17. The process of claim 15 wherein the composition is produced from a reaction mixture comprising oxides in molar ratios having a formula 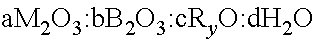
where “a” has a value of about 0.5 to 12, “b” has a value of about 1 to 36, “c” has a value of about 0.5 to 5, and “d” has a value from 30 to 1000.
